(19) United States
(12) Patent Application Publication
(10) Pub. No.: US 2024/0163307 A1
(43) Pub. Date: May 16, 2024

(54) SCALABLE SECURITY ANALYSIS OF BEHAVIORAL EVENTS

(71) Applicant: VMware, Inc., Palo Alto, CA (US)

(72) Inventors: Aditya CHOUDHARY, San Jose, CA (US); Jonathan James OLIVER, Kew (AU); Ritika SINGHAL, San Jose, CA (US); Shugao XIA, Newton, MA (US); Raghav BATTA, Livermore, CA (US); Amit CHOPRA, Cedar Park, TX (US)

(21) Appl. No.: 17/987,483

(22) Filed: Nov. 15, 2022

(51) Int. Cl. H04L 9/40

(52) U.S. Cl. CPC H04L 63/1441; H04L 63/104; H04L 63/1433

(57) ABSTRACT

A method of evaluating alerts generated by security agents installed in endpoints includes: receiving a locality-sensitive hash (LSH) value associated with an alert generated by a security agent installed in one of the endpoints; performing a search for centroids that are within a threshold distance from the received LSH value, wherein the centroids are each an LSH value that is representative of one of a plurality of groups of alerts; and assigning a security risk indicator to the alert associated with the received LSH value based on results of the search and transmitting the security risk indicator to a security analytics platform of the endpoints.

### BACKGROUND

It has become increasingly critical for security systems to generate contextual, timely, and actionable alerts such that security analysts can initiate speedy mitigation measures. Unfortunately, in a typical security operations center, the number of alerts that are generated far outnumber the number of security analysts that can effectively triage them. As a result, critical alerts are often missed by the security analysts due to fatigue and burnout. In addition, many critical alerts are identified too late for mitigation measures to be effective.

### SUMMARY

One or more embodiments provide a method of evaluating alerts generated by security agents installed in endpoints, said method comprising: receiving a locality-sensitive hash (LSH) value associated with an alert generated by a security agent installed in one of the endpoints; performing a search for centroids that are within a threshold distance from the received LSH value, wherein the centroids are each an LSH value that is representative of one of a plurality of groups of alerts; and assigning a security risk indicator to the alert associated with the received LSH value based on results of the search and transmitting the security risk indicator to a security analytics platform of the endpoints.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtual computing environment which employs a cloud-based security platform according to embodiments.

FIG. 2 is a block diagram that illustrates components of the cloud-based security platform.

FIG. 3 is a diagram that illustrates a sequence of commands issued and operations carried out to generate cluster profiles.

FIG. 4 is a diagram that illustrates a sequence of commands issued and operations carried out to generate security reports.

FIG. 5 is a flow diagram of a method of evaluating security alerts according to embodiments.

### DETAILED DESCRIPTION

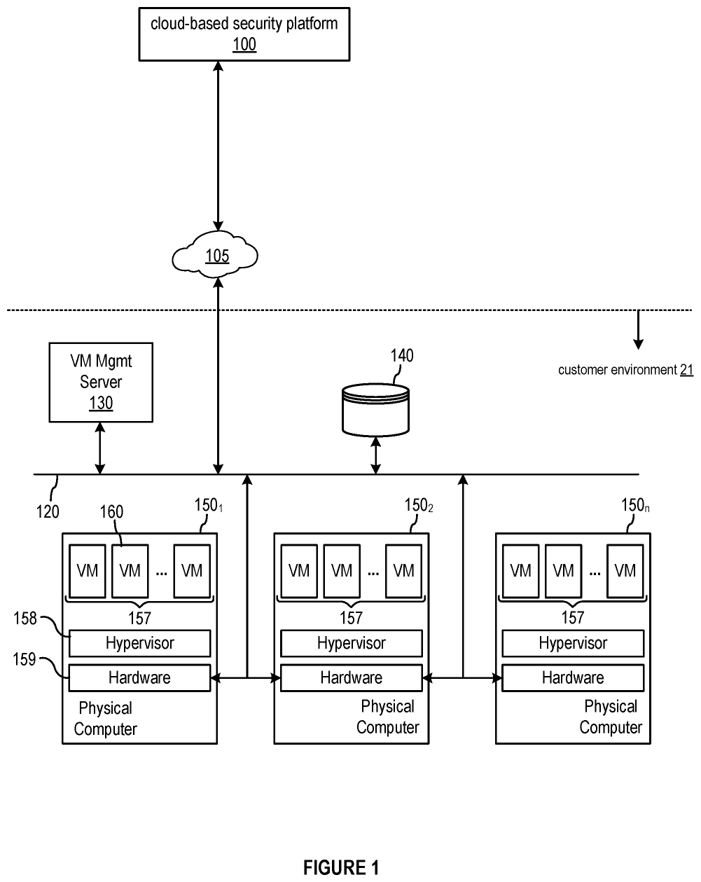

FIG. 1 is a block diagram of a virtual computing environment which is deployed in a customer environment 21 and employs a cloud-based security platform 100, according to embodiments. In the embodiments illustrated herein, virtual computing instances that are provisioned in the virtual computing environment are VMs, and the provisioning of the VMs are managed by a VM management server 130. In some embodiments, virtual computing instances provisioned in the virtual computing environment are containers.

As used herein, a “customer” is an organization that has subscribed to security services offered through cloud-based security platform 100. A “customer environment” means one or more private data centers managed by the customer, which is commonly referred to as “on-prem,” a private cloud managed by the customer, a public cloud managed for the customer by another organization, or any combination of these.

As illustrated in FIG. 1, VMs 157 are deployed on a plurality of physical computers 1501, 1502, . . . , 150n, (also referred to as “host computers”), which VM management server 130 manages as a cluster to provide cluster-level functions, such as load balancing across the cluster through VM migration between the hosts, distributed power management, dynamic VM placement according to affinity and anti-affinity rules, and high availability (HA). VM management server 130 also manages a shared storage device 140 and provisions storage resources for the cluster (e.g., one or more virtual disks 141 for each of VMs 157) from shared storage device 140.

Each of the host computers includes a hypervisor 158 (more generally, “virtualization software”) and a hardware platform 159. Hardware platform 159 contains components of a conventional computer system, such as one or more central processing units, system memory in the form of dynamic and/or static random access memory, one or more network interface controllers connected to a network 120, and a host bus adapter connected to shared storage 140. In some embodiments, hardware platform 159 includes a local storage device, such as a hard disk drive or a solid state drive, and the local storage devices of the host computers are aggregated and provisioned as shared storage device 140.

In the embodiments, security services are provided to various security endpoints, which include VMs 157, through a cloud-based security platform 100, which includes a plurality of services, each of which is running in a container or a VM that has been deployed on a virtual infrastructure of a public cloud computing system. To enable delivery of security services to VMs 157, security agents are installed in VMs 157 and the security agents communicate with cloud-based security platform 100 over a public network 105, e.g., the Internet.

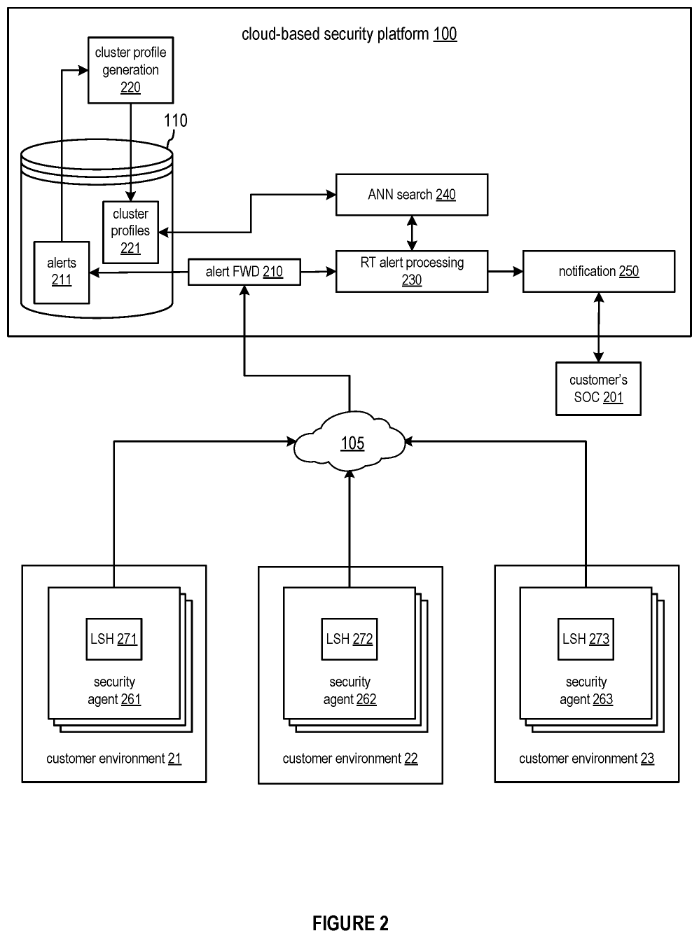

As illustrated in FIG. 2, the services include an alert forwarding service 210, a cluster profile generation service 220, a real-time alert processing service 230, an approximate nearest neighbor search service 240, and a notification service 250. Cloud-based security platform 100 also maintains databases in a storage device 110. The databases include an alerts database 211 and a cluster profiles database 221.

Alert forwarding service 210 routes security alerts that are transmitted to cloud-based security platform 100 by security agents installed in VMs which are provisioned in customer environments that employ security services provided by cloud-based security platform 100. In FIG. 2, three different customer environments, including customer environments 21, 22, 23 depicted in FIG. 1, are shown as an example. The security agents that transmit security alerts to cloud-based security platform 100 include security agents 261 that are installed in VMs of customer environment 21, security agents 262 that are installed in VMs of customer environment 22, and security agents 263 that are installed in VMs of customer environment 23.

Each security agent 261, 262, 263 includes a locality-sensitive hash (LSH) module for computing a locality-sensitive hash of the security alerts prior to transmitting them to cloud-based security platform 100. Therefore, any sensitive information contained in the security alerts is not transmitted to cloud-based security platform 100 in its raw form. As such, the security alerts handled by alert forwarding service 210 are not in their raw form. Instead, they are the LSH of the security alerts in their raw form or the LSH of the security alerts in their raw form that have been transformed in some manner. Example transforms include conversion into lowercase and applying a regular expression. Hereinafter, the security alerts in their raw form will be referred to as “raw security alerts” and the LSH of the raw security alerts or the LSH of transforms of the raw security alerts will be referred to as “LSH security alerts.” In one embodiment, an LSH module that generates a locality-sensitive hash known in the art as TLSH is used in each of security agents 261, 262, 263. This LSH engine is depicted in FIG. 2 as LSH 271 in security agent 261, LSH 272 in security agent 262, and LSH 273 in security agent 263.

In the embodiments, the LSH security alerts are generated by security agents in response to behavioral events occurring in the VMs in which the security agents are installed. A behavioral event is an event that typically changes the state of the VM and is added to various logs, including the VM's guest OS event logs, logs collected by the security agent of the VM, and logs collected by a sandbox. One example of a behavioral event in the embodiments is a PowerShell® command-line and the security agents described herein generate a security alert each time a PowerShell® command-line is executed.

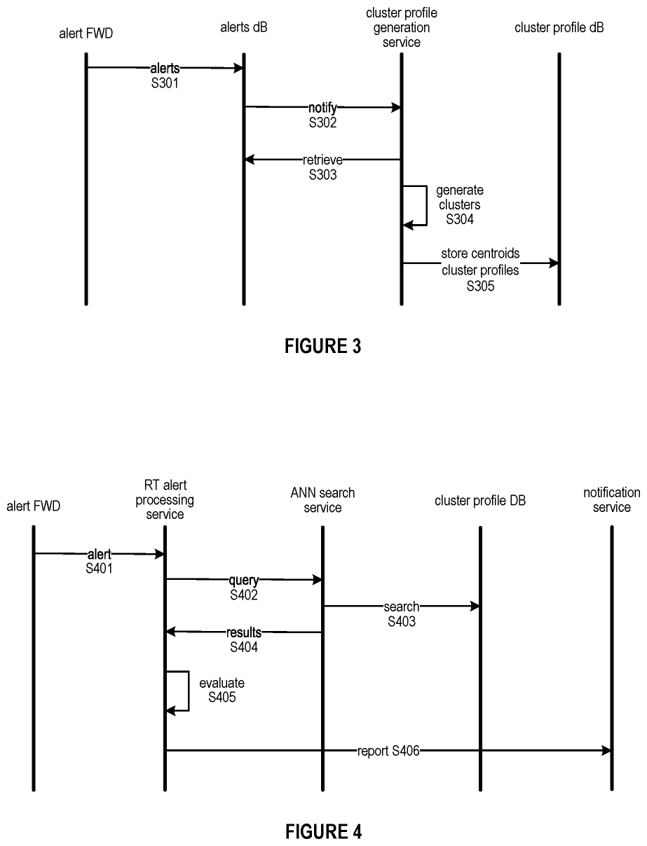

Alert forwarding service 210 routes the LSH security alerts to alerts database 211. FIG. 3 depicts a series of steps that are performed in connection with the LSH security alerts routed to alerts database 211, starting with the collection of the LSH security alerts in alerts database 211 (step S301). When a threshold number of LSH security alerts are collected in alerts database 211 for processing, cluster profile generation service 220 is notified at step S302. In response to this notification, cluster profile generation service 220 retrieves the group of LSH security alerts collected for processing at step S303 and generates clusters based on the group of LSH security alerts at step S304. Any of the well-known clustering algorithms, e.g., density-based spatial clustering of applications with noise (DBSCAN), k-means, Gaussian mixture models (GMM), and hierarchical agglomerative clustering (HAC), may be applied to the group of LSH security alerts to generate the clusters. After the clusters are generated, for each of the clusters, cluster profile generation service 220 computes a centroid, which is representative of the center all of the LSH security alerts in the cluster, and generates statistical and behavioral properties of the cluster. In one embodiment, the centroid is computed as an average of all LSH values of all of the LSH security alerts in the cluster, and the statistical and behavioral properties of the cluster include radius of the cluster, number of unique security alerts in the cluster, and whether the security alert is generated as a result of an execution of code that is backed by a certificate. At step S305, the cluster profile of each of the clusters generated at step S304, which includes its centroid and its statistical and behavioral properties, are stored in cluster profile database 221.

Alert forwarding service 210 also routes the LSH security alerts to real-time alert processing service 230. For each LSH security alert routed thereto, real-time alert processing service 230 evaluates the security risk of the behavioral event triggering the LSH security alert. FIG. 4 depicts a series of steps that are performed in connection with the LSH security alert routed to real-time alert processing service 230, starting with the receipt of the LSH security alert by real-time alert processing service 230 (step S401).

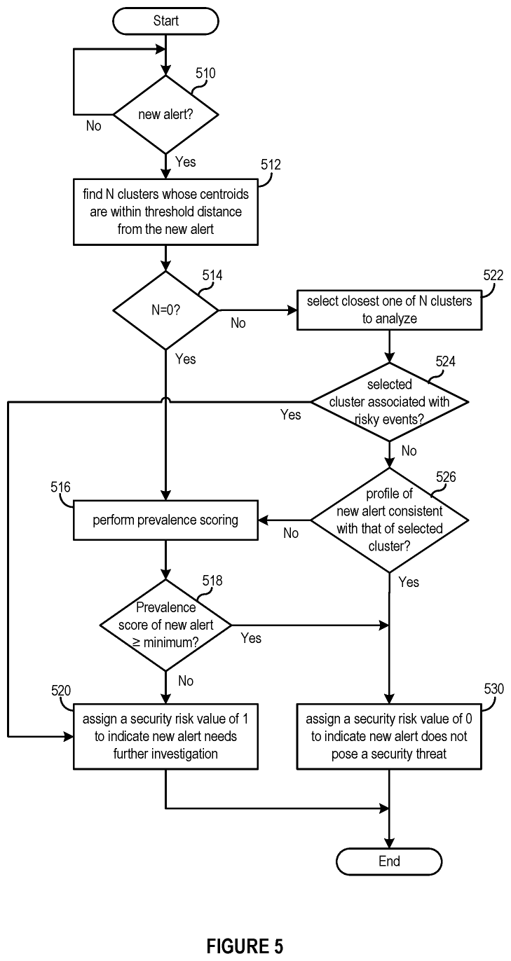

In response to the receipt of the LSH security alert, real-time alert processing service 230 issues a query to approximate nearest neighbor search service 240 at S402 for N clusters whose centroids are within a threshold distance from the LSH security alert. In response, approximate nearest neighbor search service 240 performs the search on the centroids stored in cluster profile database 221 (step S403) and returns the search results to real-time alert processing service 230 (step S404). In one embodiment, approximate nearest neighbor search service 240 performs the search employing an algorithm known in the art as the nearest neighbor descent (NN-Descent) algorithm. Then, at step S405, real-time alert processing service 230 evaluates the LSH security alert according to the method depicted in FIG. 5.

FIG. 5 is a flow diagram of a method of evaluating security alerts according to embodiments. The method begins at step 510 when real-time alert processing service 230 receives a new security alert. Then, in response thereto, at step 512, real-time alert processing service 230 issues a query to approximate nearest neighbor search service 240 for N clusters whose centroids are within a threshold distance from the new security alert. In response, approximate nearest neighbor search service 240 performs the search on the centroids stored in cluster profile database 221 and returns the search result to real-time alert processing service 230.

If no centroids are within the threshold distance from the LSH alert, the search results returned to real-time alert processing service 230 indicate N=0. In such a case (step 514, Yes), real-time alert processing service 230 performs prevalence scoring of the new security alert at step 516. In one embodiment, the prevalence scoring in the case of N=0 is carried out based on the prevalence of the same alert occurring in the same device, in the same organization, and globally during a preselected time window (e.g., 7 days). If the prevalence score is less than a minimum score (step 518, No), real-time alert processing service 230 at step 520 assigns a high security risk value (e.g., 1) to the new security alert to indicate that it needs further investigation. One example of prevalence scoring is described in U.S. patent application Ser. No. 17/984,047, filed on Nov. 9, 2022, the entire contents of which are incorporated by reference herein. On the other hand, if the prevalence score is at least the minimum score (step 518, Yes), real-time alert processing service 230 at step 530 assigns a low security risk value (e.g., 0) to the new security alert to indicate that the new security alert does not pose a security risk and does not need further investigation.

Returning to step 514, if N is not zero and there are clusters whose centroids are within the threshold distance from the new security alert, step 522 is carried out. At step 522, real-time alert processing service 230 selects the closest one of the N clusters to analyze. Then, real-time alert processing service 230 determines whether or not the selected cluster is associated with potentially risky events (i.e., contains security alerts of the type that are triggered by malicious activities). If so (step 524, Yes), real-time alert processing service 230 executes step 520 to assign the high security risk value to the new security alert. If not (step 524, No), step 526 is executed to determine whether or not the profile of the new security alert is consistent with the profile of the selected cluster. One or more of the statistical and behavioral properties stored as the cluster profile in cluster profile database 221 may be compared with the corresponding property of the new security alert to make the determination in step 526. If the profiles are not consistent (step 526, No), real-time alert processing service 230 performs prevalence scoring of the new security alert at step 516 and then executes step 518 to determine whether to assign the high security risk value (step 520) or the low security risk value (step 530). The prevalence scoring in this case is carried out based on the prevalence of the alerts similar to the new security alert (e.g., the alerts in the selected cluster) occurring in the same device, the same organization, and globally during a preselected time window (e.g., 7 days). On the other hand, if the profiles are consistent (step 526, Yes), real-time alert processing service 230 at step 530 assigns the low security risk value to the new security alert to indicate that the new security alert does not pose a security risk and does not need further investigation.

In the embodiments described above, a security risk value of 1 or 0 is assigned to each of the new security alerts that are generated. In other embodiments, the security risk may be indicated by a numerical score that is non-binary. For example, an integer score ranging from 100 (highest risk) to 0 (lowest risk) may be assigned, or a floating point score ranging from 1.0 (highest risk) to 0.0 (lowest risk) may be assigned. The scoring in both instances may be dependent on the number of risk factors applicable to the security alerts and the relative weighting given to the risk factors. In some embodiments, a machine learning algorithm is applied to a set of clusters and security alerts associated with malicious and non-malicious behavioral events to build a scoring model and the security risk of a new alert is scored using this scoring model.

After real-time alert processing service 230 completes its security risk evaluation at step S405, it reports the results of the security risk evaluation to notification service 250 (step S406). The results of the security risk assessment includes the security risk value (or score). Alternatively, the results that are returned include cluster profiles of the N clusters whose centroids are within the threshold distance from the new security alert. In response, notification 250 transmits the reports to a security analytics platform of the customer environment from which the security alert originated (e.g., customer's security operation center 201 depicted in FIG. 2).

In the embodiments, a security alert is processed without exposing the raw contents of the security alert. Therefore, the privacy of any sensitive information contained in the security alert is maintained. In addition, embodiments are applicable to behavioral events, which are fundamentally different from files and spams, which are objects of typical security software. The techniques described herein are also scalable. Forming the cluster profiles and reducing the search space enables security analysis to be performed on new events hitting client devices in real-time.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system. Computer readable media may be based on any existing or subsequently developed technology for embodying computer programs in a manner that enables them to be read by a computer. Examples of a computer readable medium include a hard drive, NAS, read-only memory (ROM), RAM (e.g., flash memory device), Compact Disk (e.g., CD-ROM, CD-R, or CD-RW), Digital Versatile Disk (DVD), magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, modifications, additions, and improvements may fall within the scope of the appended claims.

What is claimed is:

1. A method of evaluating alerts generated by security agents installed in endpoints, said method comprising:
receiving a locality-sensitive hash (LSH) value associated with an alert generated by a security agent installed in one of the endpoints;
performing a search for centroids that are within a threshold distance from the received LSH value, wherein the centroids are each an LSH value that is representative of one of a plurality of groups of alerts; and
assigning a security risk indicator to the alert associated with the received LSH value based on results of the search and transmitting the security risk indicator to a security analytics platform of the endpoints.

2. The method of claim 1, further comprising:
transmitting to the security analytics platform profiles associated with the groups of alerts that are represented by the centroids that are within a threshold distance from the received LSH value.

3. The method of claim 1, wherein the security risk indicator is a value that indicates whether or not a further investigation of the alert associated with the received LSH value needs to be carried out.

4. The method of claim 1, wherein a centroid for each group of alerts has an LSH value that is an average of LSH values of all of the alerts in the group.

5. The method of claim 1, further comprising:
comparing profiles associated with the group of alerts that are represented by a centroid that is closest in distance to the received LSH value, wherein
the security risk indicator is assigned further based on results of the comparison.

6. The method of claim 5, wherein
the security risk indicator is a value that is assigned to indicate that a further investigation of the alert associated with the received LSH value needs to be carried out if the profiles are not consistent and a prevalence of alerts in the group is less than a minimum threshold.

7. The method of claim 1, wherein
the security risk indicator is a value that is assigned to indicate that a further investigation of the alert associated with the received LSH value needs to be carried out if the group of alerts that are represented by a centroid that is closest in distance to the received LSH value includes alerts of the type that are triggered by malicious activities.

8. The method of claim 1, wherein the method is carried out by a cloud platform that delivers security services to a plurality of tenants over a network and the endpoints are computing devices communicating with the cloud platform over the network.

9. The method of claim 8, wherein the groups of alerts are clusters of alerts that are generated by a clustering algorithm applied to a plurality of alerts previously generated by security agents installed in the endpoints of the plurality of tenants.

10. A cloud platform for collecting and evaluating alerts generated by security agents installed in endpoints, the cloud platform comprising:
a data store in which locality-sensitive hash (LSH) values associated with a plurality of alerts are stored; and
a processor that is programmed to carry out the steps of:
receiving an LSH value associated with a new alert generated by a security agent installed in one of the endpoints;
performing a search for centroids that are within a threshold distance from the received LSH value, wherein the centroids are each an LSH value that is representative of one of a plurality of groups of the alerts; and
assigning a security risk indicator to the alert associated with the received LSH value based on results of the search and transmitting the security risk indicator to a security analytics platform of the endpoints.

11. The cloud platform of claim 10, the steps further comprising:
transmitting to the security analytics platform profiles associated with the groups of alerts that are represented by the centroids that are within a threshold distance from the received LSH value.

12. The cloud platform of claim 10, wherein the security risk indicator is a value that indicates whether or not a further investigation of the alert associated with the received LSH value needs to be carried out.

13. The cloud platform of claim 10, wherein a centroid for each group of alerts has an LSH value that is an average of LSH values of all of the alerts in the group.

14. The cloud platform of claim 10, the steps further comprising:
comparing profiles associated with the group of alerts that are represented by a centroid that is closest in distance to the received LSH value, wherein
the security risk indicator is assigned further based on results of the comparison.

15. The cloud platform of claim 14, wherein
the security risk indicator is a value that is assigned to indicate that a further investigation of the alert associated with the received LSH value needs to be carried out if the profiles are not consistent and a prevalence of alerts in the group is less than a minimum threshold.

16. The cloud platform of claim 10, wherein
the security risk indicator is a value that is assigned to indicate that a further investigation of the alert associated with the received LSH value needs to be carried out if the group of alerts that are represented by a centroid that is closest in distance to the received LSH value includes alerts of the type that are triggered by malicious activities.

17. The cloud platform of claim 10, wherein the method is carried out by a cloud platform that delivers security services to a plurality of tenants over a network and the endpoints are computing devices communicating with the cloud platform over the network.

18. The cloud platform of claim 17, wherein the groups of alerts are clusters of alerts that are generated by a clustering algorithm applied to a plurality of alerts previously generated by security agents installed in the endpoints of the plurality of tenants.

19. A non-transitory computer readable medium comprising instructions that are executable in a processor of a computer system to carry out a method of evaluating alerts generated by security agents installed in endpoints, said method comprising:
receiving a locality-sensitive hash (LSH) value associated with an alert generated by a security agent installed in one of the endpoints;
performing a search for centroids that are within a threshold distance from the received LSH value, wherein the centroids are each an LSH value that is representative of one of a plurality of groups of alerts; and
transmitting to a security analytics platform of the endpoints profiles associated with the groups of alerts that are represented by the centroids that are within a threshold distance from the received LSH value.

20. The non-transitory computer readable medium of claim 19, wherein the method further comprises:
assigning a security risk indicator to the alert associated with the received LSH value based on results of the search and transmitting the security risk indicator to the security analytics platform.
